(19) United States
(12) Patent Application Publication
(10) Pub. No.: US 2013/0099686 A1
(43) Pub. Date: Apr. 25, 2013

(54) LIGHT EMITTING DIODE (LED) DIMMING SYSTEM

(71) Applicants: Liang'an Ge, Hangzhou (CN); Guichao Hua, Hangzhou (CN)

(72) Inventors: Liang'an Ge, Hangzhou (CN); Guichao Hua, Hangzhou (CN)

(73) Assignee: INVENTRONICS (HANGZHOU), INC., Hangzhou, Zhejiang (CN)

(21) Appl. No.: 13/806,507

(22) PCT Filed: Nov. 9, 2010
(86) PCT No.: PCT/CN10/78554

§ 371 Date: Dec. 21, 2012

(30) Foreign Application Priority Data
Jun. 25, 2010 (CN) 201010213336.8

(51) Int. Cl. H05B 37/02

(52) U.S. Cl. CPC H05B 37/02
USPC 315/186

(57) ABSTRACT

A Light emitting diode (LED) dimming system comprises a voltage regulating converter, an input of which is connected to a power supply; a constant current module, an output of which is connected to an LED load constituted by one LED light or multiple serial LED lights; the output of the voltage regulating converter is connected with the input of the constant current module via a switch, and the switch is controlled to be on-off by an adjustable pulse signal. The invention has the advantages of high power factor and low electromagnetic interference, and easy implementation, etc.

This application claims the benefit of Chinese patent application No. 201010213336.8, titled “LED DIMMING SYSTEM”, filed with the State Intellectual Property Office on Jun. 25, 2010, which is hereby incorporated by reference in its entirety.

### FIELD OF THE INVENTION

The present invention relates to the field of electronic circuits, and in particular to a centralized-control LED dimming system.

### BACKGROUND OF THE INVENTION

LED lighting has prominent advantages such as energy saving and high photosynthetic efficiency, and is widely used in various places for illumination. When LED lighting is used, brightness of the LED load may have to be adjusted according to various requirements.

FIG. 1 illustrates a common solution for LED dimming by an external dimmer. An input line 11 and an output line 13 are provided on an LED driver 12, the LED driver 12 is connected with a power supply via the input line 11, and the output line 13 is connected with an LED for outputting driving currents for the LED. In addition, a dimming signal line connected with an external dimmer is also connected to the LED driver 12, and a dimming signal inputted into the LED driver 12 may be adjusted by a user via the external dimmer, so that the LED driver 12 adjusts the driving currents outputted to the LED according to the dimming signal.

In the above dimming manner, the dimming signal line 14 should be introduced for each independent LED light source, therefore, wirings in construction is troublesome, and the dimming signal line may subject to interference if the LED is far and thus the dimming signal line 14 has an extended length, i.e., the reliability of the system is reduced as the dimming signal line becomes longer.

FIG. 2 illustrates a diagram of an alternating current (AC) chopping-based dimming circuit, including an AC power supply 11, an LED driver 12, a dimmer 13 and multiple series-connected LED loads, a voltage outputted from the AC power supply 11, after being adjusted by the dimmer 13, is inputted into the LED driver 12 for driving the LED loads to illuminate. The dimmer 13 includes a bidirectional silicon-controlled rectifier Q1 which is provided on the line between the AC power supply 11 and the LED driver 12, and a variable resistor R1 and a capacitor C1 which are connected with each other in series and are connected with the bidirectional silicon-controlled rectifier Q1 in parallel. A control terminal of the bidirectional silicon-controlled rectifier Q1 is connected with one terminal of a trigger diode DB3, and the other terminal of the trigger diode DB3 is connected with a common terminal of the variable resistor R1 and the capacitor C1.

FIG. 3 is a waveform diagram of the voltage V1. By changing the resistance of the variable resistor R1, which in turn causes the charging time of the variable capacitor C1 to be changed and thus causes a conduction angle of the bidirectional silicon-controlled rectifier Q1 to be changed, the output voltage V1 of the dimmer 13 is changed according to chopped voltages.

It is an idea and low cost dimming solution that output currents of the LED driver 12 are controlled by varying the chopping angle of the voltage V1, however, an inherent disadvantage of chopping-based dimming is that: power factor is poor and electromagnetic interference is large in the dimming state, and there is also a problem of impedance matching between loads of the dimmer 13 and the switched-mode power supply 11 when the chopping-based dimming is applied to an LED driver of a switched-mode power supply type, and the matching problem is solved at a cost of a significantly decreased efficiency of the LED driver 12.

### SUMMARY OF THE INVENTION

An object of the present invention is to provide an LED dimming system, which has a high power factor, a low electromagnetic interference and is easy to be implemented.

The present invention provides an LED dimming system, including a voltage-regulating converter and one or more constant-current modules, wherein the voltage-regulating converter is used for outputting a constant or adjustable direct current (DC) voltage, and an input terminal of the voltage-regulating converter is connected with a power supply; input terminals of the constant-current modules are connected in parallel, and an output terminal of each of the constant-current modules is connected with an LED load including one or more series-connected LED lights, an output terminal of the voltage-regulating converter is connected with an input terminal of the constant-current module by a switch, and the switch is controlled to be turned on or turned off by an adjustable pulse signal, and under the control of the adjustable pulse signal, the constant-current module provides a constant current to a post-stage LED load if the switch is in a turn-on state, and the constant-current module does not output a current if the switch is in a turn-off state.

Preferably, the switch is a MOS transistor, an IGBT, a thyristor or a bipolar transistor.

Preferably, the voltage-regulating converter has a function of power factor correction.

Preferably, the adjustable pulse signal comprises a PWM signal and a PWM-PFM signal, the adjustable pulse signal has a frequency which ranges from 100 Hz to 10000 Hz.

Preferably, the voltage-regulating converter is an AC-DC converter or a DC-DC converter.

Preferably, the voltage-regulating converter and the switch form a centralized dimming circuit, and are set separately from each of the constant-current modules.

Preferably, the constant-current module is an isolation switch converter, a non-isolation switch converter or a linear adjusting circuit.

Preferably, the non-isolation switch converter is a buck switch converter, a boost switch converter or a buck-boost switch converter.

Preferably, the buck switch converter comprises a first switch transistor, a first inductor, a first diode and a first control circuit, a first terminal and a second terminal of the first switch transistor are connected with a positive input terminal of the constant-current module and one terminal of the first inductor respectively, the other terminal of the first inductor is connected with a positive output terminal of the constant-current module; a control terminal of the first switch transistor is connected with an output terminal of the first control circuit, and the first control circuit samples an output current at the output terminal of the constant-current module; an anode of the first diode is connected with a negative input terminal and a negative output terminal of the constant-current module, and a cathode of the first diode is connected with a common terminal of the first switch transistor and the first inductor; the first control circuit compares the sampled output current with a preset value, and controls the first switch transistor to make it turned on or turned off according to a result of the comparison, to make the constant-current module output a constant current.

Preferably, the boost switch converter comprises a second switch transistor, a second inductor, a second diode and a second control circuit, the second inductor and the second diode are series-connected between a positive input terminal and a positive output terminal of the constant-current module, an anode of the second diode is connected with the second inductor, and a cathode of the second diode is connected with the positive output terminal of the constant-current module; a first terminal and a second terminal of the second switch transistor are connected with a common terminal of the second inductor and the second diode and a negative input terminal of the constant-current module respectively, a control terminal of the second switch transistor is connected with an output terminal of the second control circuit, and an input terminal of the second control circuit samples an output current at the output terminal of the constant-current module; the second control circuit compares the sampled output current with a preset value and controls the second switch transistor to make it turned on or turned off according to a result of the comparison, to make the constant-current module output a constant current.

Preferably, the isolation switch converter is a flyback switch converter, a forward switch converter or a bridge switch converter.

Preferably, the flyback switch converter comprises a transformer, a third switch transistor and a third control circuit, a non-dotted terminal of a primary winding of the transformer is connected with a positive input terminal of the constant-current module, a dotted terminal of the primary winding of the transformer is connected with a negative input terminal of the constant-current module via a first terminal and a second terminal of the third switch transistor, a control terminal of the third switch transistor is connected with an output terminal of the third control circuit, and the third control circuit samples an output current at the output terminal of the constant-current module; a dotted terminal of a secondary winding of the transformer is connected with an anode of a third diode, a cathode of the third diode is connected with a positive output terminal of the constant-current module, and a non-dotted terminal of the secondary winding of the transformer is connected with a negative output terminal of the constant-current module; the third control circuit compares the sampled output current with a preset value, and controls the third switch transistor to make it turned on or turned off according a result of the comparison, to make the constant-current module output a constant current.

Preferably, the constant-current module is a linear adjusting circuit, an output voltage of the voltage-regulating converter follows the highest voltage of the LED loads if the switch is controlled to be turned on by the adjustable pulse signal, and the output voltage of the voltage-regulating converter is unchanged if the switch is controlled to be turned off by the adjustable pulse signal.

Preferably, the output voltage of the voltage-regulating converter follows the highest voltage of the LED loads if the switch is controlled to be turned on by the adjustable pulse signal comprises:

the voltage-regulating converter comprises a switch converting main circuit, an output characteristic parameter sampling circuit and an output voltage controller,

the output characteristic parameter sampling circuit samples a characteristic parameter outputted from the switch converting main circuit, and outputs the sampled signal of the characteristic parameter;

the output voltage controller firstly determines an adjusting direction of a magnitude of the output voltage of the output voltage adjustable circuit according to a changing relationship between the characteristic parameter sampling signal and the output voltage, and then adjusts the magnitude of the output voltage of the output voltage adjustable circuit by a certain step size according to the adjusting direction of the magnitude of the output voltage; the output voltage is adjusted by performing the above steps once or the output voltage is adjusted by performing the above steps repeatedly, to make the output voltage equal to the highest voltage of the LED loads, or make a difference between the output voltage and the highest voltage of the LED loads within a preset range.

Preferably, the linear adjusting circuit is a constant current diode.

Preferably, the linear adjusting circuit comprises a driving control circuit and an adjusting transistor, an input terminal and an output terminal of the linear adjusting circuit are connected with each other, and a first terminal and a second terminal of the adjusting transistor are series-connected between the other input terminal and the other output terminal of the linear adjusting circuit; an input signal of the driving control circuit is derived from a current sample signal of a loop that the adjusting transistor of the linear adjusting circuit and the LED load locate, and an output terminal of the driving control circuit is connected with a control terminal of the adjusting transistor, the driving control circuit samples a current of the loop that the adjusting transistor of the linear adjusting circuit and the LED load locate, compares the sampled current signal with a preset value, and controls an impedance of the adjusting transistor according to a result of the comparison, to make the constant-current module output a constant current.

Compared with the prior art, the present invention has the following advantages:

The switch is controlled to be turned on or turned off by the adjustable pulse signal to allow the adjustment of the LED loads. The brightness of the LED is centralized-adjusted directly in a PWM manner by a chopping switch, and the dimming signal is transferred by a power voltage signal without an additional dimming signal line being provided, therefore, the whole system has a good anti-interference ability, and has no requirement on distance, and thus the reliability of the dimming system is high.

Compared with the conventional thyristor dimming manner, the centralized dimming circuit constitute by the voltage-regulating converter and the switch does not require a special dimming signal detection circuit or control circuit and has a simple circuit and a high power factor, and also, in this adjusting manner, the power supply is not interfered since it is isolated by the voltage-regulating converter and the electromagnetic interference is relatively small, further, there is no problem of impedance matching between the LED load and the power supply.

In the present invention, the centralized dimming circuit and the constant-current modules may be placed independently and respectively in the whole lamp system. The voltage-regulating converter and the switch, which are used as the centralized dimmer, are placed at the outside of the lamp, and the constant-current modules may be placed at the inside of the lamp, such arrangement facilitates heat dissipation of the lamp.

### BRIEF DESCRIPTION OF THE DRAWINGS

FIG. 1 is a schematic diagram of a solution for dimming an LED by an external dimmer in the prior art;

FIG. 2 is a diagram of an existing AC chopping-based dimming circuit;

FIG. 3 is a waveform diagram of the voltage V1 in FIG. 1;

FIG. 4 is a circuit diagram of an LED dimming system according to a first embodiment of the present invention;

FIG. 5 is a waveform diagram of an input voltage V2 of a constant-current module in FIG. 3;

FIG. 6 is a circuit diagram of an LED dimming system according to a second embodiment of the present invention;

FIG. 7 is a circuit diagram of an LED dimming system according to a third embodiment of the present invention;

FIG. 8 is a circuit diagram of an LED dimming system according to a fourth embodiment of the present invention;

FIG. 9 is a circuit diagram of an LED dimming system according to a fifth embodiment of the present invention;

FIG. 10 is a circuit diagram of an LED dimming system according to a sixth embodiment of the present invention; and

FIG. 11 is a circuit diagram of an LED dimming system according to a seventh embodiment of the present invention.

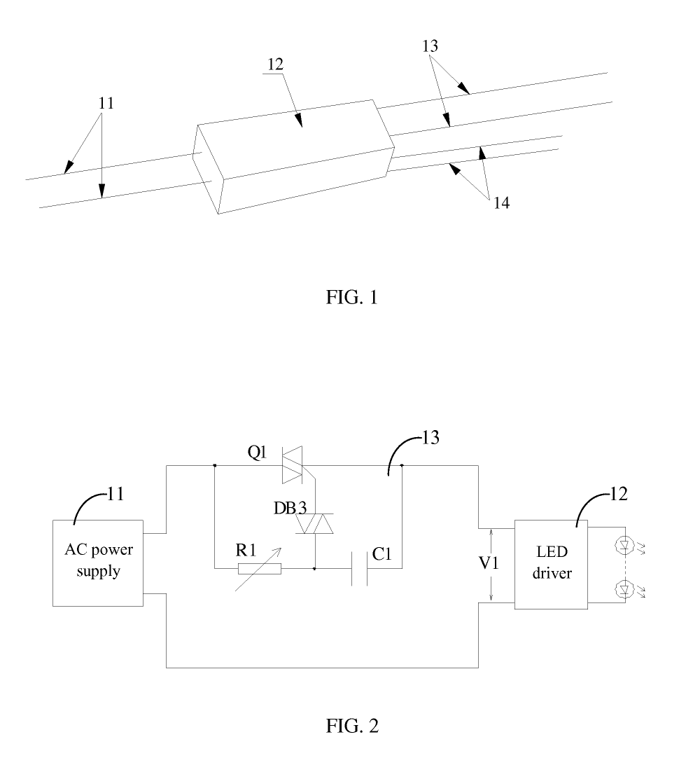

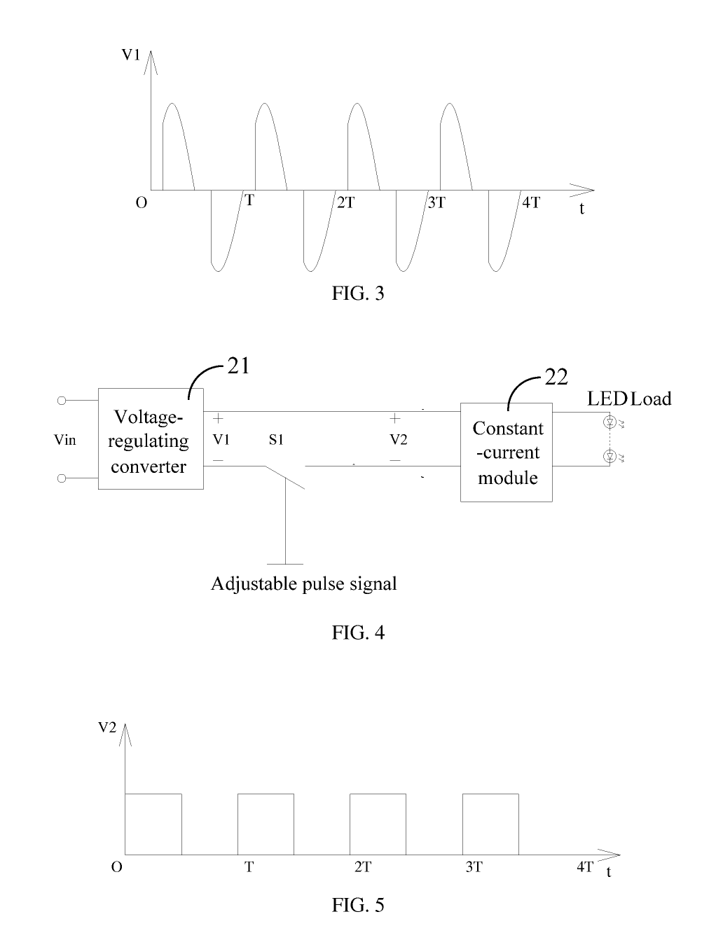

### DETAILED DESCRIPTION OF THE EMBODIMENTS

The present invention will be described in detail below in conjunction with the drawings and embodiments, to facilitate understanding of the above objections, features and advantages of the present invention.

FIG. 4 illustrates a first embodiment of the LED dimming system of the present invention, including a voltage-regulating converter 21 for outputting a constant or adjustable direct current voltage, two input terminals of the voltage-regulating converter 21 are connected with a power supply, a positive output terminal of the voltage-regulating converter 21 is connected with a positive input of a constant-current module 22, and a negative output terminal of the voltage-regulating converter 21 is connected with a negative input terminal of the constant-current module 22 via a switch 51 which is controlled to be turned on or turned off by an adjustable pulse signal, an LED load composed of one or multiple series-connected LED lights is connected between two output terminals, i.e., a positive output terminal and a negative output terminal of the constant-current module 22.

The voltage-regulating converter 21 may include a power factor correction circuit for adjusting power factors of the voltage-regulating converter 21. An output voltage V1 of the voltage-regulating converter 21 may be a preset value, or the voltage-regulating converter 21 may follow the highest voltage of the LED loads if the voltage-regulating converter 21 is followed by a constant-current module 22 constituted by a linear adjusting circuit. The voltage-regulating converter 21 may be an AC-DC converter or a DC-DC converter.

The constant-current module 22 outputs a constant current with preset amplitude during the operation.

The switch S1 is controlled by an adjustable pulse signal and operates in a turn-on/turn-off state alternately. The constant-current module operates and outputs a current with constant amplitude if the switch S1 is turned on, and the constant-current module does not operates, i.e., does not output a current if the S1 is turned off. That is, since the switch S1 operates in the turn-on/turn-off state alternately, the input voltage V2 of the constant-current module 22 is a chopped voltage, and the constant-current module 22 outputs a chopped current I2 after the output voltage V2 is inputted into the constant-current module 22, and further, by changing duty ratio of the adjustable pulse signal, which in turn causes the duty ratio of the input voltage V2 to be changed and thus causes an average of the chopped current I2 outputted from the constant-current module 22 to be changed, a centralized adjustment of brightness of the LED load can be achieve.

FIG. 5 illustrates a waveform of the input voltage V2 of the constant-current module 22, where T is equal to a period of the adjustable pulse signal, and the amplitude of V2 is equal to the amplitude of the voltage V1. In the present invention, the input voltage V2 of the constant-current module 22 is a chopped voltage, and the constant-current module 22 operates and outputs a constant current which may be a preset value if the input voltage V2 is a high level; and the constant-current module 22 does not operate and does not output the current if the input voltage V2 is a low level. The LED light is brightest if the duty ratio of the adjustable pulse signal is 100% and the LED light is extinguished if the duty ratio of the adjustable pulse signal is zero.

In the present invention, the switch S1 is controlled to be turned on or turned off by the adjustable pulse signal, and therefore the adjustment of the LED load is achieved. In this adjusting manner, the power consumption is small and the power factor is high, further, the power supply is not affected and the electromagnetic interference is relatively small since the power supply is isolated by the voltage-regulating converter 21, and also there is no problem of impedance matching between the LED driver and the power supply. Therefore, the present invention has advantages such as high power factor, small electromagnetic interference, and easy implementation.

In the present invention, the adjustable pulse signal includes a PWM-PFM signal and a PWM signal. The PWM signal has a frequency ranges from 100 Hz to 10000 Hz.

The PFM signal is a frequency modulation signal, and the PWM-PFM signal is a hybrid modulation signal of a PWM signal and a PFM signal. The hybrid modulation signal of PWM and PFM includes:

a first mode, the PWM modulation and the PFM modulation is performed alternately, for example, during a time period including time periods t1, t2, t3 and t4, the PWM modulation is performed in the time periods t1 and t3, and the PFM modulation is performed in the time periods t2 and t4.

a second mode, the PWM modulation and the PFM modulation is performed at the same time, for example, provided that a time period of a high level is ton and a time period of a low level is toff in a period T, the PWM modulation and the PFM modulation is performed at the same time means that the time period ton is changed while the time period ton is unchanged, or the time period ton is changed while the time period toff is unchanged.

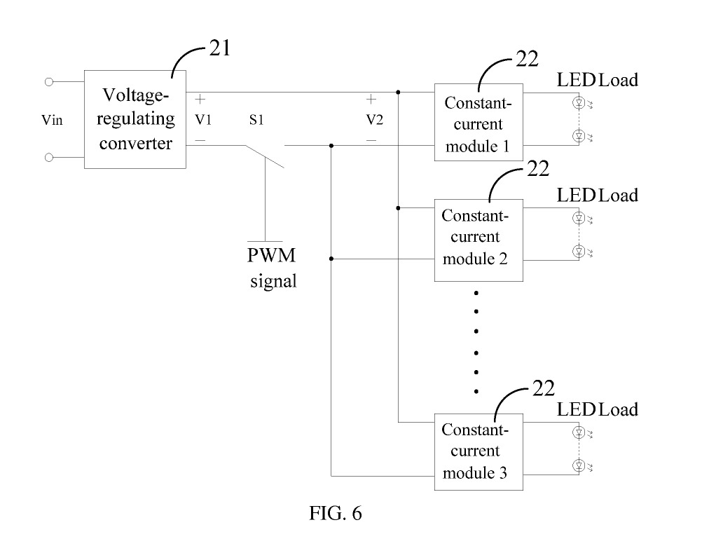

FIG. 6 illustrates a second embodiment of the LED dimming system of the present invention, including a voltage-regulating converter 21, two input terminals of the voltage-regulating converter 21 are connected with a power supply, and a positive output terminal and a negative output terminal of the voltage-regulating converter 21 are respectively connected with a positive input terminal and a negative input terminal of each of constant-current modules 22 with the input terminals paralleled-connected, an LED load including one or more series-connected LED lights is connected between two output terminals, i.e., a positive output terminal and a negative output terminal of each constant-current module 22; a switch S1 which is controlled to be turned on or turned off by a PWM signal is connected between the negative output terminal of the voltage-regulating converter 21 and the negative input terminals of the constant-current modules 22. The constant-current modules 22 may output currents with different amplitudes according to requirements of the LED loads, that is, may be used with different LED loads.

In the present invention, multiple groups of LED loads are controlled by multiple constant-current modules 22 respectively, and a centralized control of the multiple groups of LED loads is achieved.

In the present invention, the constant-current module 22 may be a DC-DC converting circuit, such as a BUCK circuit, a BOOST circuit, a Flyback circuit.

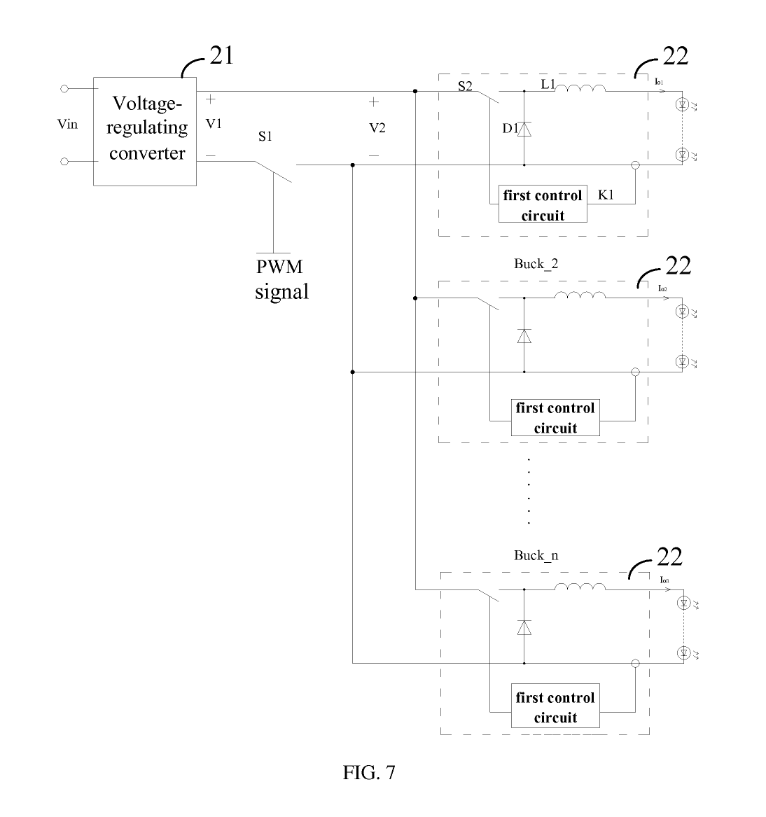

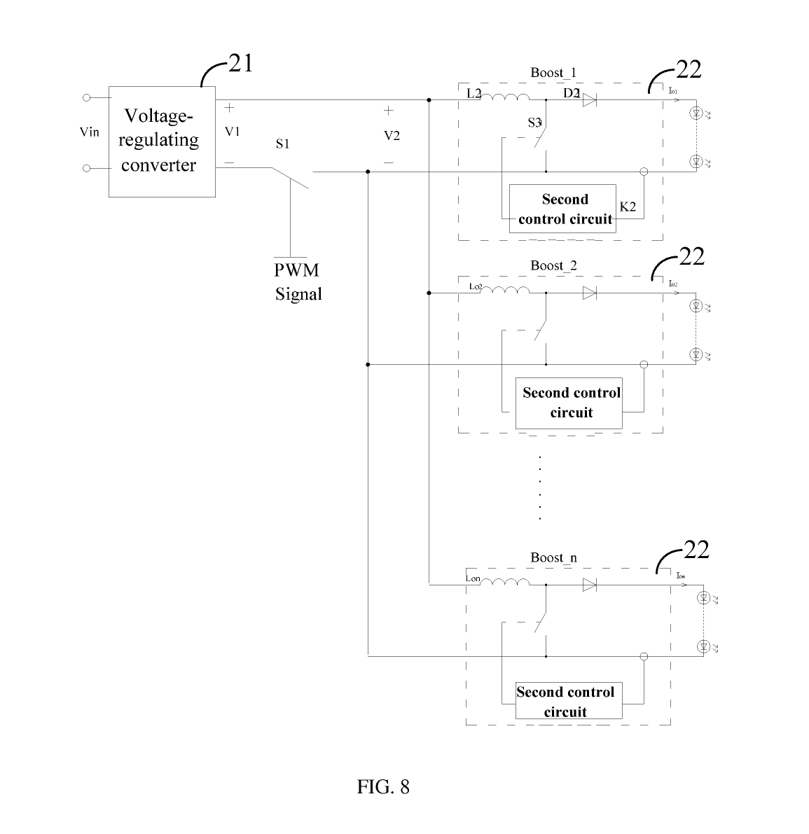

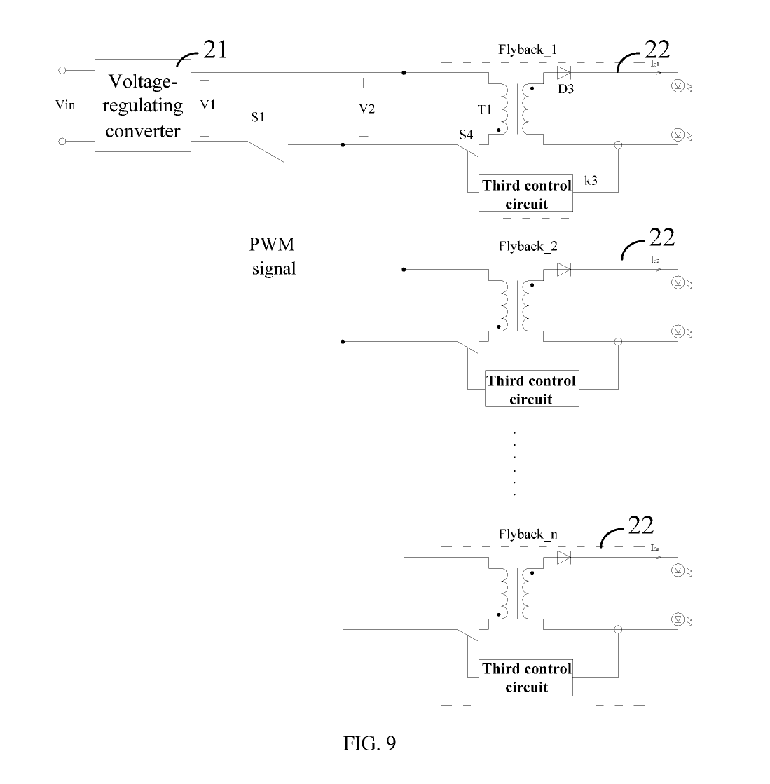

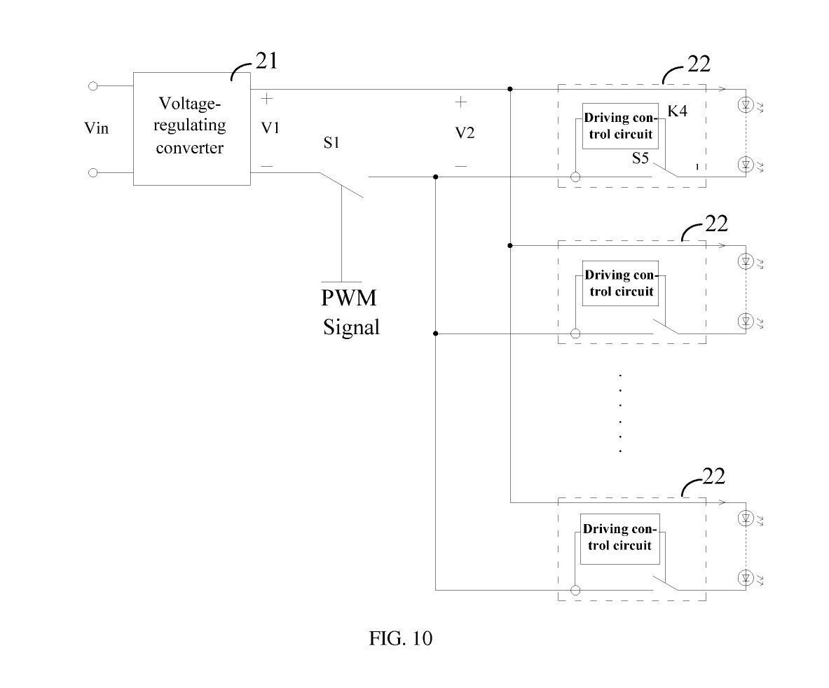

In the present embodiment, the adjustable pulse signal is a PWM signal, and it should be noted that the PWM-PFM signal is also applicable to the present embodiment. In embodiments of FIG. 7, FIG. 8, FIG. 9 and FIG. 10 below, the PWM signal is used as an example and it should be noted that the PWM-PFM signal is also applicable to these embodiments.

FIG. 7 illustrates a third embodiment of the LED dimming system of the present invention. The constant-current module 22 includes a first switch transistor S2, a first terminal and a second terminal of the first switch transistor S2 are connected with a positive input terminal of the constant-current module 22 and one terminal of a first inductor L2 respectively, and the other terminal of the first inductor L1 is connected with a positive output terminal of the constant-current module 22. A control terminal of the first switch transistor S2 is connected with an output terminal of a first control circuit K1, and an input terminal of the first control circuit K1 samples the output current of the constant-current module 22. A negative input terminal of the constant-current module 22 is connected with an anode of a first diode D1, and a cathode of the first diode D1 is connected with a common terminal of the first switch transistor S2 and the first inductor L1. The control terminal of the first switch transistor S2 controls the first terminal and the second terminal to make the first switch transistor S2 turned on or turned off.

The first control circuit samples the output current Io, compares the sampled output current Io with a preset value, and controls the first switch transistor S2 to make it turned on or turned off according to the result of the comparison, to make the constant-current module 22 output a constant current.

FIG. 8 illustrates a fourth embodiment of the LED dimming system of the present invention. A second inductor L2 and a second diode D2 are series-connected between the positive input terminal and the positive output terminal of the constant-current module 22. An anode of the second diode D2 is connected with the second inductor L2, and a cathode of the second diode D2 is connected with the positive output terminal of the constant-current module 22. A first terminal and a second terminal of a second switch transistor S3 are connected with a common terminal of the second inductor L2 and the second diode D2 and the negative input terminal of the constant-current module 22 respectively, a control terminal of the second switch transistor S3 is connected with an output terminal of a second control circuit K2, and an input terminal of the second control circuit K2 samples the output current of the constant-current module 22. The control terminal of the second switch transistor S3 controls the second switch transistor S3 to make it turned on or turned off.

The second control circuit K2 samples the output current Io, compares the output current Io with a preset value, and controls the second switch transistor S3 to make it turned on or turned off according to the result of the comparison, to make the constant-current module 22 output a constant current.

FIG. 9 illustrates a fifth embodiment of the LED dimming system of the present invention. The constant-current module 22 includes a transformer T1, a non-dotted terminal of a primary winding of the transformer is connected with the positive input terminal of the constant-current module 22, and a dotted terminal of the primary winding of the transformer is connected with the negative input terminal of the constant-current module 22 via a first terminal and a second terminal of a third switch transistor S4. A control terminal of the third switch transistor S4 is connected with an output terminal of a third control circuit K3, and an input terminal of the third control circuit K3 samples the output current of the constant-current module 22. A dotted terminal of a secondary winding of the transformer T1 is connected with an anode of the third diode D3, and a cathode of the third diode D3 is connected with the positive output terminal of the constant-current module 22. A non-dotted terminal of the secondary winding of the transformer is connected with the negative output terminal of the constant-current module 22. A control terminal of the third switch transistor S4 controls the third switch transistor S4 to make it turned on or turned off.

The third control circuit K3 samples the output current Io, compares the sampled output current Io with a preset value, and controls the third switch transistor S4 to make it turned on or turned off according to the result of the comparison, to make the constant-current module 22 output a constant current.

FIG. 10 illustrates a sixth embodiment of the LED dimming system of the present invention. The constant-current module 22 is a linear adjusting circuit, including a driving control circuit K4 and an adjusting transistor S5.

An input terminal and an output terminal of the linear adjusting circuit are connected with each other, and a first terminal and a second terminal of the adjusting transistor S5 are series-connected between the other input terminal and the other output terminal of the linear adjusting circuit. In the drawing, a positive input terminal and a positive output terminal of the linear adjusting circuit are connected with each other, and the first terminal and the second terminal of the adjusting transistor S5 are series-connected between a negative input terminal and a negative output terminal of the linear adjusting circuit.

An input signal of the drive control circuit K4 is derived from a current sample signal of a loop that the adjusting transistor S5 of the linear adjusting circuit and the LED load locate, and an output terminal of the drive control circuit K4 is connected with a control terminal of the adjusting transistor S5.

The drive control circuit K4 samples the current of the loop that the adjusting transistor S5 of the linear adjusting circuit and the LED load locate, compares the sampled current signal with a preset value, and controls impedance of the adjusting transistor S5 according to the result of the comparison, to make the constant-current module 22 output a constant current.

It should be noted that, in the embodiment illustrated in FIG. 10, the positive input terminal and the positive output terminal of the linear adjusting circuit are connected with each other, and the first terminal and the second terminal of the adjusting transistor are series-connected between the negative input terminal and the negative output terminal of the linear adjusting circuit.

However, other embodiments not illustrated in FIG. 10 may be: an input terminal and an output terminal of the linear adjusting circuit are connected with each other, and the first terminal and the second terminal of the adjusting transistor are series-connected between the other input terminal and the other output terminal of the linear adjusting circuit:

the negative input terminal and the negative output terminal of the linear adjusting circuit are connected with each other, and the first terminal and the second terminal of the adjusting transistor are series-connected between the positive input terminal and the positive output terminal of the linear adjusting circuit.

It should be noted that, since an input terminal and an output terminal of the linear adjusting circuit are connected, the adjusting transistor of the linear adjusting circuit forms a series loop together with a post-stage LED load, and thus the current sample signal inputted into the drive control circuit K4 may be the current sampled at any point of the series loop, that is, the input signal of the drive control circuit is a current signal sampled at any of the input terminals and the output terminals of the linear adjusting circuit.

It should be noted that in the present embodiment, the input signal of the drive control circuit K4 is derived from the current sample signal of the loop that the adjusting transistor S5 of the linear adjusting circuit and the LED load locate, it can be understood that the current signal inputted into the drive control circuit K4 may be obtained in a sampling resistance manner, that is, a sampling resistor is series-connected to any point of the series loop formed by the adjusting transistor and a post-stage LED load, and the signal of two ends of the sampling resistor is used as the input signal of the drive control circuit K4.

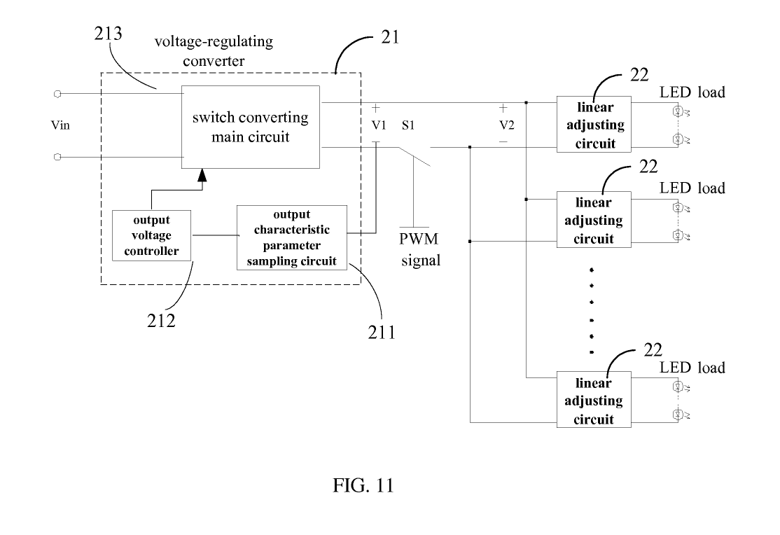

FIG. 11 illustrates a seventh embodiment of the LED dimming system of the present invention. The constant-current module 22 is a linear adjusting circuit, the output voltage of the voltage-regulating converter 21 follows the highest voltage of the LED loads if the switch S1 is controlled to be turned on by the adjustable pulse signal, and the output voltage of the voltage-regulating converter 21 is unchanged if the switch S1 is controlled to be turned off by the adjustable pulse signal.

The voltage-regulating converter 21 includes a switch converting main circuit 213, an output characteristic parameter sampling circuit 211 and an output voltage controller 212; where if the switch S1 is controlled to be turned on by the adjustable pulse signal:

the output characteristic parameter sampling circuit 211 samples the characteristic parameter outputted from the switch converting main circuit 213, and outputs the sampled signal of the characteristic parameter;

the output voltage controller 212 firstly determines an adjusting direction of a magnitude of the output voltage of the output voltage adjustable circuit according to a changing relationship between the sampled signal of the characteristic parameter and the output voltage, and then adjusts the magnitude of the output voltage of the output voltage adjustable circuit by a certain step size according to the adjusting direction of the magnitude of the output voltage, where the output voltage is adjusted by performing the above steps once, or the output voltage is adjusted by performing the above steps repeatedly, to make the output voltage equal to the highest voltage of the LED loads, or make a difference between the output voltage and the highest voltage of the LED loads within a preset range.

The output voltage controller 212 does not output the signal for adjusting the output voltage, or the control signal outputted from the output voltage controller 212 is unchanged and the output voltage of the voltage-regulating converter 21 is unchanged, if the switch S1 is controlled to be turned off by the adjustable pulse signal.

It should be noted that in the output voltage controller 212, determining the adjusting direction of the magnitude of the output voltage of the output voltage adjustable circuit according to the changing relationship between the sampled signal of the characteristic parameter and the output voltage is as follow:

(1) the output voltage adjustable circuit increases the output voltage by a certain step size on a basis of a last output voltage, and detects the variation of the output current, the adjusting direction of the output voltage is increase if the output current increases as the output voltage increases; and the adjusting direction of the output voltage is decrease if the output current is unchanged as the output voltage increases;

(2) the output voltage adjustable circuit decreases the output voltage by a certain step size on a basis of a last output voltage, and detects the variation of the output current, the adjusting direction of the output voltage is decrease if the output current is unchanged as the output voltage decreases; and the adjusting direction of the output voltage is increase if the output current decreases as the output voltage decreases.

It should be noted that the characteristic parameter outputted from the switch converting main circuit 213 includes all parameters that can represent the output of the switch converting main circuit. Preferably, the output characteristic parameter is an output current, i.e., the output characteristic parameter sampling circuit 211 samples the output current of the switch converting main circuit 213.

In the present invention, the brightness of the LED is adjusted directly in a PWM manner by the chopping switch, and a special dimming signal detection circuit or control circuit is not required for a post-stage DC/DC circuit. The frequency of the PWM square waveform is allowed in a broad range, and the duty ratio of the switch is the duty ratio of a post-stage circuit for PWM dimming, therefore, a standard design in the industry is easy to be formed. Compared with the phase angle chopping-based dimming of the leading edge or the trailing edge AC power supply, in the present invention, the AC side of the power grid has a good electromagnetic compatibility.

The above mentioned is merely preferable embodiments of the present invention, and does not intent to limit the protection scope of the present invention. Any amendments, equivalent substitutions or improvements within spirit and principle of the present invention are all included in the protection scopes of claims of the present invention.

1. An LED dimming system, comprising a voltage-regulating converter and one or more constant-current modules, wherein
the voltage-regulating converter is used for outputting a constant or adjustable direct current voltage, and an input terminal of the voltage-regulating converter is connected with a power supply;
input terminals of the constant-current modules are connected in parallel, and an output terminal of each of the constant-current modules is connected with an LED load comprising one or more series-connected LED lights,
an output terminal of the voltage-regulating converter is connected with an input terminal of the constant-current module by a switch, and the switch is controlled to be turned on or turned off by an adjustable pulse signal, and
under the control of the adjustable pulse signal, the constant-current module provides a constant current to a post-stage LED load if the switch is in a turn-on state, and the constant-current module does not output a current if the switch is in a turn-off state.

2. The LED dimming system according to claim 1, wherein the switch is a MOS transistor, an IGBT, a thyristor or a bipolar transistor.

3. The LED dimming system according to claim 1, wherein the voltage-regulating converter has a function of power factor correction.

4. The LED dimming system according to claim 1, wherein the adjustable pulse signal comprises a PWM signal and a PWM-PFM signal, the adjustable pulse signal has a frequency which ranges from 100 Hz to 10000 Hz.

5. The LED dimming system according to claim 1, wherein the voltage-regulating converter is an AC-DC converter or a DC-DC converter.

6. The LED dimming system according to claim 1, wherein the voltage-regulating converter and the switch form a centralized dimming circuit, and are set separately from each of the constant-current modules.

7. The LED dimming system according to claim 1, wherein the constant-current module is an isolation switch converter, a non-isolation switch converter or a linear adjusting circuit.

8. The LED dimming system according to claim 7, wherein the non-isolation switch converter is a buck switch converter, a boost switch converter or a buck-boost switch converter.

9. The LED dimming system according to claim 8, wherein the buck switch converter comprises a first switch transistor, a first inductor, a first diode and a first control circuit,
a first terminal and a second terminal of the first switch transistor are connected with a positive input terminal of the constant-current module and one terminal of the first inductor respectively, the other terminal of the first inductor is connected with a positive output terminal of the constant-current module; a control terminal of the first switch transistor is connected with an output terminal of the first control circuit, and the first control circuit samples an output current at the output terminal of the constant-current module; an anode of the first diode is connected with a negative input terminal and a negative output terminal of the constant-current module, and a cathode of the first diode is connected with a common terminal of the first switch transistor and the first inductor;
the first control circuit compares the sampled output current with a preset value, and controls the first switch transistor to make it turned on or turned off according to a result of the comparison, to make the constant-current module output a constant current.

10. The LED dimming system according to claim 8, wherein the boost switch converter comprises a second switch transistor, a second inductor, a second diode and a second control circuit,
the second inductor and the second diode are series-connected between a positive input terminal and a positive output terminal of the constant-current module, an anode of the second diode is connected with the second inductor, and a cathode of the second diode is connected with the positive output terminal of the constant-current module; a first terminal and a second terminal of the second switch transistor are connected with a common terminal of the second inductor and the second diode and a negative input terminal of the constant-current module respectively, a control terminal of the second switch transistor is connected with an output terminal of the second control circuit, and an input terminal of the second control circuit samples an output current at the output terminal of the constant-current module; the second control circuit compares the sampled output current with a preset value and controls the second switch transistor to make it turned on or turned off according to a result of the comparison, to make the constant-current module output a constant current.

11. The LED dimming system according to claim 7, wherein the isolation switch converter is a flyback switch converter, a forward switch converter or a bridge switch converter.

12. The LED dimming system according to claim 11, wherein the flyback switch converter comprises a transformer, a third switch transistor and a third control circuit,
a non-dotted terminal of a primary winding of the transformer is connected with a positive input terminal of the constant-current module, a dotted terminal of the primary winding of the transformer is connected with a negative input terminal of the constant-current module via a first terminal and a second terminal of the third switch transistor, a control terminal of the third switch transistor is connected with an output terminal of the third control circuit, and the third control circuit samples an output current at the output terminal of the constant-current module; a dotted terminal of a secondary winding of the transformer is connected with an anode of a third diode, a cathode of the third diode is connected with a positive output terminal of the constant-current module, and a non-dotted terminal of the secondary winding of the transformer is connected with a negative output terminal of the constant-current module;
the third control circuit compares the sampled output current with a preset value, and controls the third switch transistor to make it turned on or turned off according a result of the comparison, to make the constant-current module output a constant current.

13. The LED dimming system according to claim 1, wherein the constant-current module is a linear adjusting circuit, an output voltage of the voltage-regulating converter follows the highest voltage of the LED loads if the switch is controlled to be turned on by the adjustable pulse signal, and the output voltage of the voltage-regulating converter is unchanged if the switch is controlled to be turned off by the adjustable pulse signal.

14. The LED dimming system according to claim 13, wherein the output voltage of the voltage-regulating converter follows the highest voltage of the LED loads if the switch is controlled to be turned on by the adjustable pulse signal:
the voltage-regulating converter comprises a switch converting main circuit, an output characteristic parameter sampling circuit and an output voltage controller,
the output characteristic parameter sampling circuit samples a characteristic parameter outputted from the switch converting main circuit, and outputs the sampled signal of the characteristic parameter;
the output voltage controller firstly determines an adjusting direction of a magnitude of the output voltage of the output voltage adjustable circuit according to a changing relationship between the characteristic parameter sampling signal and the output voltage, and then adjusts the magnitude of the output voltage of the output voltage adjustable circuit by a certain step size according to the adjusting direction of the magnitude of the output voltage; the output voltage is adjusted by performing the above steps once or the output voltage is adjusted by performing the above steps repeatedly, to make the output voltage equal to the highest voltage of the LED loads, or make a difference between the output voltage and the highest voltage of the LED loads within a preset range.

15. The LED dimming system according to claim 7, wherein the linear adjusting circuit is a constant current diode.

16. The LED dimming system according to claim 7, wherein the linear adjusting circuit comprises a driving control circuit and an adjusting transistor,
an input terminal and an output terminal of the linear adjusting circuit are connected with each other, and a first terminal and a second terminal of the adjusting transistor are series-connected between the other input terminal and the other output terminal of the linear adjusting circuit;
an input signal of the driving control circuit is derived from a current sample signal of a loop that the adjusting transistor of the linear adjusting circuit and the LED load locate, and an output terminal of the driving control circuit is connected with a control terminal of the adjusting transistor,
the driving control circuit samples a current of the loop that the adjusting transistor of the linear adjusting circuit and the LED load locate, compares the sampled current signal with a preset value, and controls an impedance of the adjusting transistor according to a result of the comparison, to make the constant-current module output a constant current.

17. The LED dimming system according to claim 7, wherein the constant-current module is a linear adjusting circuit, an output voltage of the voltage-regulating converter follows the highest voltage of the LED loads if the switch is controlled to be turned on by the adjustable pulse signal, and the output voltage of the voltage-regulating converter is unchanged if the switch is controlled to be turned off by the adjustable pulse signal.
